(19) United States
(12) Patent Application Publication
(10) Pub. No.: US 2013/0133373 A1
(43) Pub. Date: May 30, 2013

(54) SILICON REFINING EQUIPMENT

(71) Applicants: Christophe Lafon, Saint Marcel D'Ardeche (FR); Roger Boen, Saint Alexandre (FR); Lionel Bruguiere, Saint Aunes (FR); Christophe Girold, Piolenc (FR); Florent Lemort, Villeneuve Les Avignon (FR); Armand Bonnetier, Orange (FR); Pascal Rivat, Saint Etienne De Saint Geoirs (FR); Jean-Pierre Del Gobbo, Saint Martin D'Uriage (FR); Daniel Delage, Gieres (FR)

(72) Inventors: Christophe Lafon, Saint Marcel D'Ardeche (FR); Roger Boen, Saint Alexandre (FR); Lionel Bruguiere, Saint Aunes (FR); Christophe Girold, Piolenc (FR); Florent Lemort, Villeneuve Les Avignon (FR); Armand Bonnetier, Orange (FR); Pascal Rivat, Saint Etienne De Saint Geoirs (FR); Jean-Pierre Del Gobbo, Saint Martin D'Uriage (FR); Daniel Delage, Gieres (FR)

(73) Assignee: COMMISSARIAT A L'ENERGIE ATOMIQUE, Paris (FR)

(21) Appl. No.: 12/527,036

(22) PCT Filed: Feb. 12, 2008
(86) PCT No.: PCT/FR2008/050220

§ 371 Date: Nov. 9, 2009

(30) Foreign Application Priority Data
Feb. 14, 2007 (FR) 0753256

(51) Int. Cl. C03B 5/225; C03B 5/02

(52) U.S. Cl. CPC C03B 5/225; C03B 5/021
USPC 65/135.6; 65/355; 65/356

(57) ABSTRACT

The invention relates to equipment for refining a load of silicon(s) that comprises a crucible (5) including at least one sole (20) made of a first refractory material having good heat conductivity, means (26, 28) for cooling the sole, a protection member (30) made of at least a second refractory material having low heat conductivity and to be provided between the crucible and the load, and induction heating means (23, 24) of the load including a winding (23) provided in or under the sole.

### FIELD OF THE INVENTION

The present invention relates to the manufacturing of silicon to form cells of electric power generation by photovoltaic effect. This silicon of higher grade than metallurgical silicon is generally designated as solar grade or SoG silicon.

### DISCUSSION OF PRIOR ART

Currently, the silicon intended for photovoltaic techniques is essentially formed of scrap of the microelectronics industry, since the silicon used for photovoltaic applications can contain a proportion of impurities (on the order of one part per million) which is less critical than the impurity level (on the order of one part per billion) generally required in microelectronics.

As a second silicon source for producing silicon adapted to photovoltaic products, it has already been provided to refine the silicon manufactured for metallurgical applications. The silicon used in metallurgy basically contains several percents of impurities such as iron, titanium, boron, phosphorus, etc. which must be eliminated (taken down to much lower contents).

For example, document EP-A-0459421 describes a silicon purification method, where an arc plasma is directed towards the surface of a silicon melt contained in a hot crucible with a silica wall (SiO₂). The high speed of the plasma sets the melt into motion with an intensity depending on the power of the plasma. A hot crucible with a wall of a refractory material is a type of industrial crucible currently used in the metallurgical industry.

A disadvantage of this technique is that the silicon already heated by the electromagnetic excitation of the coil surrounding the hot crucible is submitted to an additional heating due to the plasma. This additional heating typically is of several hundred degrees and makes the silicon melt reach the melting temperature of the silica wall. Indeed, the melting temperature of silica is higher by approximately 200° C. than that of silicon. The melting of the walls creates a risk as to the security of the installation, due to the possible liquid metal leakage.

It could have been envisaged to increase the thickness of the silica walls. This however discards the inductive excitation winding used to heat the silicon, which poses efficiency problems. In practice, a hot crucible has a limiting wall thickness of at least a few centimeters.

Another disadvantage of hot crucibles, which are generally solid for tightness reasons, is that in case of an incidental solidification of the melted silicon inside of the crucible, the silicon expansion linked to the cooling breaks the crucible, which then cannot be repaired. This disadvantage is particularly disturbing in industrial applications. Indeed, silicon is one of the few metals which significantly expands during its cooling and especially as it passes from the liquid phase to the solid phase. Its density decreases from 2.6 in the liquid state to approximately 2.34 in the solid state. The resulting expansion during the cooling is sufficient to break a crucible.

In a hot inductive crucible, the number of turns of the inductive winding around the crucible is relatively small. Generally, for a homogeneous distribution of the field, from six to some twelve spirals, distributed across the height of the crucible, are provided. The spirals are spaced apart from one another across the crucible height, still for field homogeneity reasons, and also for electric isolation reasons. Accordingly, even if the winding itself is cooled (for example, by the flowing of water inside of the spirals), this is not sufficient to cool down the external crucible wall, especially due to the interval between the different turns across the height thereof.

To do away with the disadvantages due to the use of a hot inductive crucible, it has already been provided to use a cold inductive crucible (or sectorized crucible) to refine silicon. French patent application 2871151 filed by the CNRS describes a silicon refining installation implementing a sectorized cold crucible, surrounded with a winding, by means of which a turbulent stirring of the silicon melt is organized, a plasma generated by an inductive plasma torch being directed towards the surface of the melt to eliminate impurities. Elements of a refractory material are interposed between the silicon melt and the cold crucible to be able to maintain the silicon melt at a high temperature. This enables to decrease the manufacturing cost of the purified silicon, which is essentially due to the processing time, and thus to the temperature of the silicon melt likely to be obtained.

However, a disadvantage of such a refining installation is that the manufacturing of a cold sectorized crucible is particularly difficult and expensive.

### SUMMARY OF THE INVENTION

The present invention aims at providing a silicon purification installation, especially intended for photovoltaic applications, using a cold crucible and which does not have the disadvantages of a conventional inductive cold crucible.

The present invention also aims at providing a solution compatible with the use of a plasma torch directed towards the surface of the melt to eliminate impurities.

The present invention also aims at improving the security of the installation in case of an incidental or voluntary cooling of the silicon melt causing its solidification.

To achieve all or part of these objects as well as others, the present invention provides an installation for the refining of a silicon load, comprising a crucible comprising at least one sole formed of at least one first refractory material which is a good heat conductor; means for cooling down the sole; a protection element formed of at least one second refractory material which is a poor heat conductor, and intended to be interposed between the crucible and the load; and means for heating the sole by induction of the load comprising a winding arranged in or under the sole.

According to an embodiment, the sole is a crossed by a pipe inside of which a cooling fluid is intended to flow, said pipe being made of the second refractory material, of a third refractory material, or of an electrically conductive material.

According to an embodiment, the winding corresponds to a hollow tube inside of which a cooling fluid is intended to flow.

According to an embodiment, the protection element corresponds to a powder comprising at least the second refractory material, the protection element having a pocket-shaped surface and being intended to contain the load.

According to an embodiment, the protection element further comprises carbon at least at the level of said surface.

According to an embodiment, the sole comprises a rounded surface on the side of the load.

According to an embodiment, the protection element comprises a portion covering the rounded surface, said portion having a thickness which is constant to within 10%.

According to an embodiment, the winding takes on the shape of the rounded surface.

According to an embodiment, the installation further comprises a plasma torch intended to be directed towards the free surface of the load.

According to an embodiment, the crucible further comprises a lateral metal wall at the periphery of the sole, the installation comprising means for cooling the lateral wall.

According to an embodiment, the lateral wall corresponds to a single-piece metal part comprising a cavity in which a cooling fluid is intended to flow.

The present invention also provides a method for refining a silicon load comprising the steps of providing a crucible comprising at least one sole of at least one first refractory material which is a good heat conductor; arranging in the crucible a protection element formed of at least one second refractory material which is a poor heat conductor; placing the load on the protection element; cooling down the sole; and heating the load by induction heating means comprising a winding arranged in or under the sole.

According to an embodiment, the protection element corresponds to a powder comprising at least the second refractory material, the method comprising distributing the powder in the crucible by forming a pocket-shaped surface intended to contain the load.

### BRIEF DESCRIPTION OF THE DRAWINGS

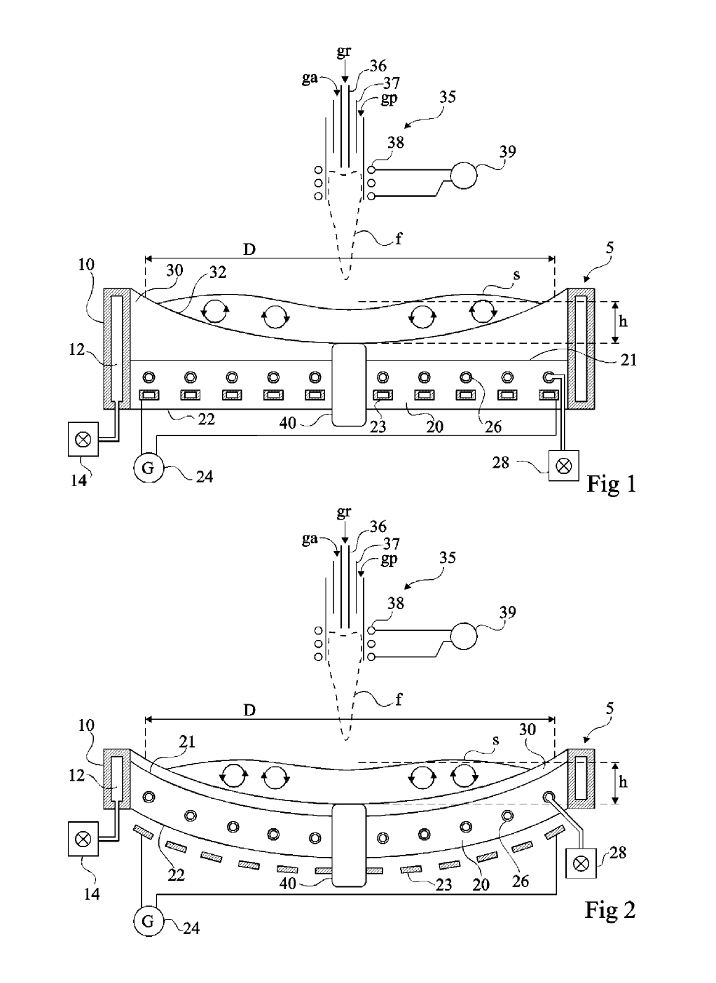

The foregoing and other objects, features and advantages of the present invention will be discussed in detail in the following non-limiting description of specific embodiments in connection with FIGS. 1 and 2 which are simplified cross-section views of embodiments of a silicon refining installation according to the invention.

### DETAILED DESCRIPTION

For clarity, the same elements have been designated with the same reference numerals in the different drawings. Only those components which are useful to the understanding the invention have been shown in the drawings and will be described hereafter. In particular, the constitutive details as well as the gases used in the plasma torch have not been detailed, the present invention being compatible with conventional plasma torch refining methods. Further, the frequencies and intensities of excitation of the inductive windings have not been detailed, the invention being here again compatible with usual techniques of determination of these frequencies and intensities.

A feature of the present invention is to provide a crucible comprising a cooled-down sole, also called bottom or floor, made of a refractory material and to provide inductive means for heating the silicon melt comprising a coil which is arranged in the sole or under the sole. The cooled-down lateral wall of the crucible, when present, can then be non-sectorized, which simplifies the manufacturing of the crucible. Another feature of the present invention is to interpose a protection element of a refractory material which is a poor conductor of the heat between the cold crucible and the silicon melt. This enables to maintain the silicon melt at a high temperature.

FIG. 1 schematically shows an embodiment of a refining installation comprising a crucible 5 containing a silicon melt s. Crucible 5 comprises a cylindrical lateral wall 10 with a circular base, made of a metallic material, for example, copper or stainless steel. Wall 10 contains a cavity 12 in which a cooling fluid (for example, water or air) flows. The installation comprises an element 14 intended to organize the flow of the cooling fluid in cavity 12. Crucible 5 further comprises a sole 20, also called floor or bottom, for example, silicon-carbide based refractory cement, comprising opposite planar upper and lower surfaces 21 and 22. Upper surface 21 is located on the side of silicon melt s and lower surface 22 is located on the side opposite to silicon melt s. A planar winding 23 or coil of a material which is a good electric conductor, for example, copper, is arranged in sole 20. Winding 23 is supplied by a low-frequency generator 24 (G) (typically from a few tens to a few tens of thousands of hertz). When a current flows through winding 23, an inductive heating of silicon melt s is obtained. The fact of providing winding 23 directly at the level of sole 20 enables to obtain an efficient electromagnetic coupling between winding 23 and silicon melt s. Sole 20 may be crossed by a cooling pipe 26 in which a cooling fluid (for example, water) flows. Cooling pipe 26 may be interposed between upper surface 21 and winding 23 to decrease the heat flow reaching winding 23. Pipe 26 for example has a circular or square cross-section and may be made of a refractory material which is a good heat conductor, for example, a silicon carbide-based material. Pipe then is advantageously substantially transparent to the electromagnetic field emitted by coil 23. This enables to improve the efficiency of the refining process. However, to decrease costs and/or ease the manufacturing process, pipe 26 may be made of a material which is a good conductor both of heat and electricity, for example, copper or stainless steel. A minimum clearance between two portions of pipe 26 of at least two or three millimeters is then provided to limit disturbances of the electromagnetic field emitted by coil 23 and to obtain a satisfactory output. The refining installation comprises an element 28 intended to organize the flow of the cooling fluid inside of pipe 26.

According to a variation, winding 23 may be arranged on the side of upper surface 21, that is, interposed between upper surface 21 and cooling pipe 26.

According to another variation, winding 23 may correspond to a hollow tube inside of which flows a cooling fluid, for example, water. In this case, sole 20 may be directly cooled by the cooling fluid flowing inside of winding 23. Cooling pipe 26 may then be omitted.

According to another variation, winding 23 may be arranged under sole 20 close to lower surface 22 of sole 20.

According to another variation, cooling pipe 26 may be arranged in sole 20 to at least partially project from upper surface 21.

A protection element 30 made of a refractory material which is a poor heat conductor is interposed between crucible 5 and silicon melt s. The material forming protection element 30 is selected so that it does not chemically react or that it only slightly reacts with molten silicon. It may for example be a powder of a refractory material, such as alumina, quartz, zirconia, or silica, or a mixture or two or more of these materials. An advantage of forming protection element 30 only based on silica for a silicon refining application is that this minimizes the introduction of impurities originating from protection element 30 itself into silicon melt s to be processed. The powder forming protection element 30 may be arranged in crucible 5 manually or via a feed hopper. The powder is then packed down to be as compact as possible and to define a pocket-shaped surface 32 containing silicon melt s, for example, conical, spherical, or elliptic, which is as continuous as possible. For this purpose, a powder of very thin grade may be used, for example, a powder with a grade below 10 micrometers. The fact for protection element 30 to be formed of a non-sintered powder enables to ease the forming of surface 32 of protection element 30 containing silicon melt s. Indeed, once the powder has been arranged in crucible 5, surface 32, which is for example pocket-shaped, may be very simply formed by pressing of the powder via a plunger.

The thickness of protection element 30 is sufficient to limit the heat flow from silicon melt s to sole 20 and lateral wall 10. As an example, the minimum thickness of protection layer 30 is greater than at least one millimeter, and preferably greater than 5 millimeters. Protection element 30 further prevents a direct contact between silicon melt s and lateral wall 10 and sole 20 of crucible 5. This enables to form lateral wall 10 with a low-cost metal, for example, stainless steel, while maintaining the silicon melt at a high temperature. Further, the use of a powder to form protection element 30 provides a protection in case of an unwanted cooling of the molten silicon. Indeed, in case of a solidification, the silicon tends to expand and to exert a pressure on protection element 30. Protection element 30, which has a powdery consistency, tends to deform easily, thus decreasing the strain on lateral wall 10 and sole 20 of crucible 5.

According to a variation, protection element 30 also comprises a carbon powder, for example, graphite, which may be mixed to the rest of protection element 30 or which may correspond to a layer of a pure carbon powder arranged at the level of surface 32 of protection element 30. The carbon may be used to trap by capillarity certain impurities of the molten silicon (especially, iron and/or boron) of silicon melt s which tend to react with the carbon. As an example, in the case where the carbon is arranged in the form of a layer covering surface 32 of protection element 30, the forming of a silicon carbide layer at the level of surface 32 of protection element 30 can even be observed in operation.

According to another variation, silicon melt s may not be in direct contact with protection element 30. Indeed, silicon melt s may be contained in an intermediary crucible made of a refractory material, for example, silica, the intermediary crucible being arranged in contact with protection element 30. The intermediary crucible may be single-piece or may be formed of several pieces connected to one another.

According to another variation, protection element 30 may be rigid and correspond to a single-piece or be formed of several pieces connected to one another. Protection element 30 is for example obtained by sintering of a powder of a refractory material. Protection element 30 is then arranged in crucible 5 in contact with lateral wall 10 and sole 20 and defines an internal volume receiving silicon melt s.

FIG. 2 shows another embodiment of crucible 5 in which upper surface 21 of sole 20 has a rounded shape, for example corresponding to an ellipsoid portion, to a spherical portion, to a cone, etc. Protection element 30 may then correspond to a layer of a powder of a refractory material or of several refractory materials, this layer being uniformly arranged on upper surface 21 of sole 20. As an example, the thickness of protection layer 30 may be constant to within 10% and greater than at least one millimeter and, preferably, greater than 5 millimeters. This has the advantage of enabling a better control of the heat exchanges between silicon melt s and sole 20. Sole 20 may have a constant thickness so that lower surface 22 of sole 20 also has a rounded shape which reproduces the shape of upper surface 21.

In the present embodiment, coil 23 is arranged under lower surface 22 of sole 20, and advantageously takes on its shape. According to a variation, coil 23 is arranged in sole 20, for example, close to upper surface 21 of sole 20, and takes on its shape.

According to a variation of the present embodiment, the curvature of sole 20 may be sufficient for lateral wall 10 to be absent. Crucible 5 is then directly held at the level of sole 20.

In the previously-described embodiments, the dimensions of crucible 5, and especially the dimensions of protection element 30, are such that silicon melt s is generally contained in a cylindrical volume of diameter D and of height h such that the ratio between height h and diameter D is smaller than 0.5, preferably, smaller than 0.1.

For the previously-described embodiments, an inductive plasma torch 35 is provided, and placed so that flame f of the plasma licks the free surface of silicon melt s. The device for holding plasma torch 35 is not shown. The function of the plasma is to create a medium formed of the free radicals and of the ions of the plasmagene gas(es) in the vicinity of the free surface of the melt. The atmosphere thus created is extremely reactive and the impurities present at the surface of the melt combine with the reactive gas of the plasma and become volatile (or, conversely, solid) at the melt surface temperature. The whole installation is maintained under a controlled atmosphere, which enables to progressively carry off the molecules containing the impurities.

Plasma torch 35 for example comprises a inlet 36 of reactive gas gr at the center of the torch, a concentric inlet 37 of an auxiliary gas ga (for example, argon). A plasma gas gp (for example, also argon) is further conveyed concentrically to auxiliary gas ga. An induction coil 38 surrounds the free end of torch 35 to create the inductive plasma. Coil 38 is generally excited by an A.C. current at a frequency on the order of one megahertz by a generator 39. Conventionally, different reactive gases may be injected into the plasma, either simultaneously or successively for their selective actions on the unwanted elements.

Crucible 5 of the previously-described embodiments may comprise a casting device 40 located, for example, at the bottom and at the center of sole 20. Casting device 40 is, for example, formed of a port initially closed by means of a flap or a slide valve placed under protection element 30. Protection element 30 advantageously protects casting device 40 from the direct contact with the silicon in the silicon melting and purification phase. Casting device 40 may also comprise a sintered silicon washer device or stopper-rod assembly. As a variation, casting device 40 may be absent. Crucible 5 may then be assembled on a rotating element, not shown, enabling to pour down its content.

An example of a silicon refining method that can be implemented with the previously-described refining installation examples will now be described.

At the beginning, protection element 30 is arranged in crucible 5 and given a shape in the case where protection element 30 has a powdery consistency. Protection element 30 is then filled with a silicon load s formed of powder, of chips, or of silicon scrap. As an example, a load from 200 to 400 kg may be arranged in protection element 30. Since silicon is a semiconductor, it must be preheated before becoming progressively conductive (around 800° C.) and being then capable of being heated by induction by means of coil 23.

For example, plasma torch 35 is first actuated to preheat the solid silicon load and to take it to the temperature enabling to obtain a coupling with the low-frequency field created by coil 23 of crucible 5. The gas used during this preheating phase preferably is argon. Hydrogen may be introduced as a reactive gas to increase the thermal conductivity of the plasma and thus accelerate the preheating of the silicon load.

At the end of this starting phase, the silicon is completely melted and the power necessary to maintain this molten state is essentially provided by coil 23 of crucible 5.

In a second phase, a turbulent stirring of the melt is performed in the direction indicated by the arrows in FIGS. 1 and 2, and one or several reactive gases appropriate for the elimination of the impurities which, by combining with a reactive gas at the surface of melt s, form volatile species which vaporize, are introduced into the plasma.

In a third possible phase, the silicon thus purified may be doped with elements enhancing the photovoltaic power of the polysilicon by passivation or the defects, for example, with hydrogen.

The silicon, once refined and possibly doped, is emptied from crucible 5 via casting device 40 or by inclination of crucible 5. Part of the molten silicon may be left in crucible 5 to enhance the melting of solid silicon pieces added to crucible 5 for the processing of a new silicon load.

The forming of an electromagnetic field in liquid silicon melt s which has a high fluidity (viscosity of only 6.88·10⁻³ Pa·s at 1,500° C.) enables to perform an efficient stirring which enhances the purification by aggregation of the impurities, and their subsequent “skimming” from the melt surface. The applicant has shown by simulation that electromagnetic forces in silicon melt s are essentially vertical, which is favorable to the stirring and thus to the silicon purification. This rise is also favored by the small relative depth of the melt due to the low shape of crucible 5. Diameter D of silicon melt s (associated with its small height h) enables to obtain a purification by an efficient surface “evaporation” while enabling the processing of a significant amount of silicon for each silicon load to be processed. Further, the small relative depth of crucible 5 enables to easily almost totally carry off the molten silicon by moderately tilting the crucible.

Of course, the present invention is likely to have various alterations and modifications which will occur to those skilled in the art. In particular, the gases used will be selected according to the impurities to be eliminated. Further, determining the dimensions of the different elements of the installation is within the abilities of those skilled in the art based on the functional indications given hereabove and on the application. In particular, although a cylindrical crucible with a circular base has been described, the use of a tapered crucible or of a crucible with a square or rectangular base may be provided. Further, although a refining method using a plasma torch has been described, the purification of the molten silicon may be performed by any adapted means. In particular, a system for injecting reactive gas bubbles directly into the molten silicon may be used.

1. An installation for the refining of a silicon load (s), comprising:
a crucible (5) comprising at least one sole (20) formed of at least one first refractory material which is a good heat conductor;
means (26, 28) for cooling down the sole;
a protection element (30) formed of at least one second refractory material which is a poor heat conductor, intended to be interposed between the crucible and the load; and
means (23, 24) for heating the sole by induction of the load comprising a winding (23) arranged in or under the sole.

2. The installation of claim 1, wherein the sole (20) is a crossed by a pipe (26) inside of which a cooling fluid is intended to flow, said pipe being made of the second refractory material, of a third refractory material, or of a material which is a good electric conductor.

3. The installation of claim 1 or 2, wherein the winding (23) corresponds to a hollow tube inside of which a cooling fluid is intended to flow.

4. The installation of any of claims 1 to 3, wherein the protection element (30) corresponds to a powder comprising at least the second refractory material, the protection element having a pocket-shaped surface (32) and being intended to contain the load (s).

5. The installation of claim 4, wherein the protection element (30) further comprises carbon at least at the level of said surface (32).

6. The installation of any of claims 1 to 5, wherein the sole (20) comprises a rounded surface (21) on the side of the load (s).

7. The installation of claim 6, wherein the protection element (30) comprises a portion covering the rounded surface (21), said portion having a constant thickness to within 10%.

8. The installation of claim 6 or 7, wherein the winding (23) takes on the shape of the rounded surface (21).

9. The installation of any of claims 1 to 8, wherein further comprising a plasma torch (35) intended to be directed towards the free surface of the load (s).

10. The installation of any of claims 1 to 9, wherein the crucible (5) further comprises a lateral metal wall (10) at the periphery of the sole (20), the installation comprising means (12, 14) for cooling the lateral wall.

11. The installation of claim 10, wherein the lateral wall (10) corresponds to a single-piece metal part comprising a cavity (12) in which a cooling fluid is intended to flow.

12. A method for refining a silicon load (s) comprising the steps of:
providing a crucible (5) comprising at least one sole (20) of at least one first refractory material which is a good heat conductor;
arranging in the crucible a protection element (30) formed of at least one second refractory material which is a poor heat conductor;
placing the load on the protection element;
cooling down the sole; and
heating the load by induction heating means (23, 24) comprising a winding (23) arranged in or under the sole.

13. The method of 12, wherein the protection element (30) corresponds to a powder comprising at least the second refractory material, the method comprising distributing the powder in the crucible (5) by forming a pocket-shaped surface (32) intended to contain the load (s).
